(19) United States
(12) Patent Application Publication
(10) Pub. No.: US 2024/0003467 A1
(43) Pub. Date: Jan. 4, 2024

(54) BIMETALLIC PRODUCTION TUBING

(71) Applicant: OBSHCHESTVOS OGRANICHENNOY OTVETSTVENNOSTYU TORGOVYY DOM<<SOYEDINITELNYYE DETALI TRUBOPROVODOV>>, Samara (RU)

(72) Inventor: Sergei Viktorovich NOVIKOV, Samara (RU)

(21) Appl. No.: 18/032,256

(22) PCT Filed: Aug. 19, 2021
(86) PCT No.: PCT/RU2021/050268

§ 371 Date: Apr. 17, 2023

(30) Foreign Application Priority Data
Dec. 4, 2020 (RU) 2020139968

(51) Int. Cl. F16L 9/04; F16L 58/18

(52) U.S. Cl. CPC F16L 9/04; F16L 58/185; E21B 17/00

(57) ABSTRACT

The proposed utility model relates to production tubing, and more particularly to tubing that is suitable for a whole range of operations related to the oil industry, geological prospecting and drilling. A bimetallic production tubing comprises a main outer pipe made of carbon steel and, immediately adjacent same, a thin-walled inner pipe made of stainless steel. The thin-walled inner pipe is fitted inside the outer tube by plastic deformation of the thin-walled inner pipe such as to lie in complete and direct contact with the inner surface of the main outer pipe. The technical result of the claimed utility model is that of simplifying the structure of a production tubing, while at the same time increasing the durability thereof.

### FIELD OF THE INVENTION

The invention relates to a production tubing, and more particularly to a tubing that is suitable for a whole range of operations related to the oil industry, geological prospecting, and drilling.

### BACKGROUND OF THE INVENTION

A production tubing is generally used in wells in which liquid and gaseous media having a high corrosive activity move according to a technological scheme. It is apparent that a substance comes from the well under high pressure and at high temperature; according to these conditions, the main requirement applied for products is their resistance to increased values of this parameter.

The production tubing is classified according to the nature of the substance extracted from the well: oil, gas, or water.

Due to their purpose and increased performance requirements, these products must meet the necessary safety standards and be labeled accordingly.

Currently, the main method of protection against corrosion of the production tubing is the application of special paints and varnishes based on epoxy resins. The disadvantages of such coatings are their low resistance to variable mechanical and high-temperature effects.

Trouble spots are both the body of the production tubing and the threads of pipes and sleeves of the production tubing. To protect the thread, various anti-corrosion and anti-friction thread coatings are used, as well as special gaskets (streamers), which are installed at the junction of two pipes and prevent the penetration of an aggressive medium to the thread. The most difficult task is to provide reliable protection against corrosion processes of the body of the production tubing exposed to extreme mechanical loads at high temperatures in highly aggressive variable media.

When it is planned to move a particularly corrosive working medium through a pipeline, the production tubing is made not from carbon steel of various grades, but from stainless steel grades. However, the manufacture of such stainless-steel production tubing is prohibitively expensive.

WO 9839592 discloses a lining process which consists in inserting a thin-walled pipe into the internal cavity of the production tubing, pumping an adhesive composition between the pipe and the production tubing, equalizing the pressure between the thin-walled pipe and the production tubing, as well as inside the thin-walled pipe, and then drying the resulting product.

This product has significant disadvantages, namely the complexity of its manufacturing, since the pumping of the adhesive composition and the pressure equalization are long and complex processes. In addition, since the pipe and the production tubing are exposed, during their use, to high pressure, large temperature changes, and the pumping of aggressive media, the adhesive composition is exposed to aggressive deformation and destruction, which leads to the rapid failure of the thin-walled inner pipe and, accordingly, the entire production tubing. Thus, the design of this production tubing is unreliable, and its production is expensive and complicated.

### SUMMARY OF THE INVENTION

The object of the invention is to eliminate the above-indicated disadvantages of the prior art.

The technical result of the invention is to simplify the design of the production tubing while increasing its durability.

The technical result is achieved by that a bimetallic production tubing comprises a main outer pipe made of carbon steel and a thin-walled inner pipe made of stainless steel, which is directly adjacent to the main outer pipe. The thin-walled inner pipe is fitted inside the main outer tube due to plastic deformation of the thin-walled inner pipe such as to lie in complete and direct contact with the inner surface of the main outer pipe, thereby repeating its microprofile.

### BRIEF DESCRIPTION OF THE DRAWINGS

The invention is further explained by using the drawings and the detailed description.

FIG. 1 shows a general view of a production tubing.

FIG. 2 shows a fixture (special equipment) for forming the inner surface of the production tubing.

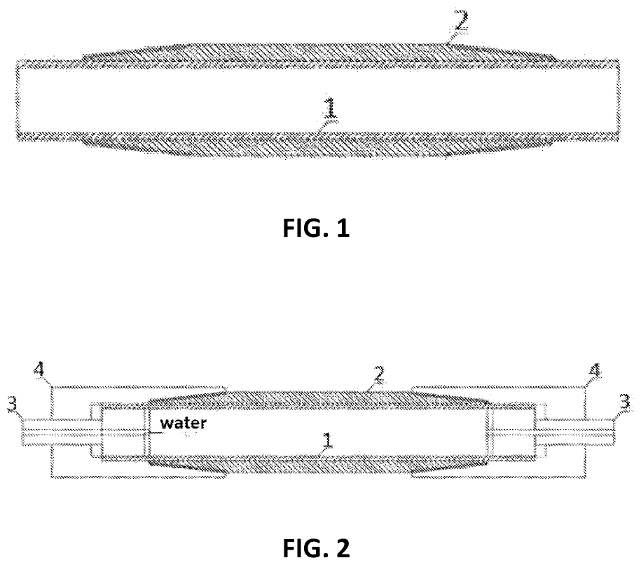

### DETAILED DESCRIPTION OF THE INVENTION

A bimetallic production tubing comprises a main outer pipe 2 made of carbon steel. A thin-walled inner pipe 1, which is made of stainless steel, is directly adjacent to the outer pipe 2. The thin-walled inner pipe 1 is fitted inside the outer pipe 2 due to plastic deformation of the thin-walled inner pipe 1. The plastic deformation process is carried out as follows. The thin-walled inner pipe 1 is inserted into the inner cavity of the outer pipe 2, and the ends are sealed using special equipment (see FIG. 2). Then, the inner cavity of the thin-walled pipe 1 is filled with liquid (water) under high pressure, which creates a stress in the metal above the yield point and, accordingly, the plastic deformations of the metal of the thin-walled pipe 1 occur, i.e., its permanent deformity. The pressure generated is not enough to deform the main thick-walled pipe 2. Thus, the thin-walled pipe 1 fits snugly against the inner surface of the pipe 2 in a slightly stressed state, which ensures its stable position during operation. This ensures a complete direct fit of the outer surface of the inner thin-walled pipe 1 to the inner surface of the main outer pipe 2.

The thin-walled pipe is selected as follows: a steel grade, depending on a medium to be transported, is usually AISI 304 stainless steel or Russian analogue 08X18H10, but there may be another steel grade. The thickness is determined based on mechanical properties; strength and fluidity indicators should provide the plastic deformations of the metal without destroying the surface within the annulus between the thin-walled and thick-walled pipes.

As a rule, the thickness of the thin-walled pipe ranges from 0.8 to 1.5 mm.

The diameter of the blank of the thin-walled pipe is determined based on a tolerance field for the inner diameter of the thick-walled pipe. The outer diameter is selected such that the pipe annulus is as small as possible.

The process of forming the inner surface of the production tubing from thin-walled stainless steel can be described in more detail using special equipment (see FIG. 2).

The thin-walled pipe 1 is inserted into the internal cavity of the main pipe 2. The ends of the thin-walled pipe are sealed using special equipment 3. Then, the special sealing equipment 3 is fixed with special locking sleeves 4 screwed onto the thread present at the ends of the main pipe. The thread on the locking sleeves must match the thread on the main pipes. The sealing equipment 3 and the locking sleeves 4 are made for a specific pipe size and are replaceable. Next, the inner cavity of the thin-walled pipe 1 is filled with water under high pressure, which creates stress in the metal above the yield point and causes the plastic deformations of the metal. The pressure value is selected such that it is sufficient to create the plastic deformations of the thin-walled pipe 1 but not enough to plastically deform the main pipe 2. Thus, the thin-walled pipe 1 expands, its length decreases, and the wall thickness reduces, and it fits snugly against the inner surface of the main pipe 2, repeating its microprofile.

After the pressure is removed and the water is drained from the internal cavity of the already bimetallic pipe, the body of the stainless pipe remains in a light stressed state, which ensures its stable position in the body of the main pipe during operation. Thus, since the thin-walled inner pipe directly adjoins the main outer pipe, repeating its microprofile, and said adjoining is provided by means of plastic deformation using water pressure, a snug fit is achieved without the formation of cavities between the two pipes and the occurrence of mechanical damage to the inner surface of the stainless pipe. Thus, when pumping a medium under pressure, the inner pipe will firmly rest on the outer one, thereby excluding possible deformation changes. Temperature changes and the aggressiveness of media also have a minimal effect on this pipe because both pipes are made of metal and have similar expansion coefficients. At the same time, during pumping of the medium, deformation is also excluded, since the inner pipe adjoins the main outer pipe as tightly as possible (repeating its microprofile), i.e., there are no air gaps between them. Thus, the simplification of the design of the production tubing protected from corrosion is ensured, as well as an increase in its durability.

1. A bimetallic production tubing comprising:
a main outer pipe made of carbon steel, and
a thin-walled inner pipe made of stainless steel, the thin-walled inner pipe being directly adjacent to the main outer pipe,
wherein the thin-walled inner pipe is fitted inside the main outer tube due to plastic deformation of the thin-walled inner pipe such as to lie in complete and direct contact with an inner surface of the main outer pipe, thereby repeating a microprofile of the main outer pipe.

2. The bimetallic production tubing of claim 1, wherein the thin-walled inner pipe is made of AISI 304/08X18H10 stainless steel.
